(19) United States
(12) Patent Application Publication
(10) Pub. No.: US 2006/0221986 A1
(43) Pub. Date: Oct. 5, 2006

(54) An Arrangement, a Functional Means and a Method in a Network Supporting Communication of Packet Data

(76) Inventor: Micael Berg, Goteborg (SE)

Correspondence Address: ERICSSON INC., 6300 LEGACY DRIVE, M/S EVR C11, PLANO, TX, 75024, US

(21) Appl. No.: 11/277,635

(22) Filed: Mar. 28, 2006

(30) Foreign Application Priority Data
Mar. 29, 2005 (SE) 0500736-4

(51) Int. Cl. H04Q 7/00; H04L 12/56

(52) U.S. Cl. 370/401; 370/328

(57) ABSTRACT

The present invention relates to an arrangement, in a communications system supporting communication of packet data, for selection of a packet data gateway node or function for a mobile user station (MS; UE). It comprises a packet data gateway functional selection means, said gateway functional selection means is adapted to use a number of information parameters contained in a context set up message to select packet data gateway, and it is adapted to forward the context set up message to the selected packet data gateway node or packet data gateway function.

### CROSS-REFERENCE TO RELATED APPLICATIONS

This application claims the benefit of Swedish patent application number 0500736-4, filed Mar. 29, 2005, the disclosure of which is fully incorporated herein by reference.

### FIELD OF THE INVENTION

The invention relates, in general, to packet data communications, and, in particular, to advanced GGSN selection.

### BACKGROUND

According to the 3GPP (Third Generation Partnership Project) TS 23.060, appendix A, APN (Access Point Name) and GGSN (Gateway GPRS Support Node), the SGSN (Serving GPRS Support Node) shall use the APN to derive the GGSN address (to be used for a mobile user station requesting a communication (service) set up. However, to base the selection of GGSN on the APN tends to be unsatisfactory for several reasons since, today, the trend within tele/datacommunication is to use a so called single APN solution. Hence, instead of using different APN:s for different services, e.g. MMS should use one APN, Internet browsing another, etc. as it had original intention, many operators today actually require that all services should be accessed using one and the same APN. One of the reasons therefor is that the scenario with multiple APN:s (e.g. different APN:s for different services) require complex and complicated terminal (mobile user station) configuration settings. It is however difficult to select a GGSN if there is only one APN. APN cannot anymore be seen as a part of a service.

For very large networks this does also not function. Such networks would have to be divided into “subnetworks” but there is no support therefor in 3GPP.

It is disadvantageous that all GGSN:s (or GGSN “part” of a CGSN, Combined GSN, having the functionality of a SGSN as well as of a GGSN) with the same APN have to have the same service capacity, that they have to be upgraded at the same time etc. It is also a prerequiste in such a solution that all GGSN:s hosting the same APN must offer the same or equal services, e.g. HSDPA capabilities, pre-/post paid supports etc.

### SUMMARY OF THE INVENTION

What is needed is therefor an arrangement as initially referred to through which GGSN can be selected in a flexible manner. Particularly an arrangement is needed which allows for GGSN:s with different support of services, differently upgraded GGSN:s, GGSN:s of different capacities etc.

A node or selection function means is also needed through which one or more of the above mentioned objects can be achieved. Still further a method for selection of GGSN (or GGSN part of CGSN) is needed through which one or more of the above mentioned objects can be achieved and/or through which GGSN etc. can be selected in an easy and flexible manner.

### BRIEF DESCRIPTION OF THE DRAWINGS

The invention will in the following be further described in a non-limiting manner, and with reference to the accompanying drawings, in which:

FIG. 1 is a sequence diagram illustrating the procedure of advanced GGSN selection according to the invention,

FIG. 2 is a block diagram illustrating an embodiment in which the functional selection means is implemented as a stand-alone node,

FIG. 3 is a block diagram of an embodiment with a functional selection means implemented in an SGSN,

FIG. 4 is a block diagram of an embodiment in which the functional selection means is implemented in a GGSN, and

FIG. 5 is a block diagram illustrating an embodiment in which the functional selection means is implemented in a DNS (Domain Name Server).

### DETAILED DESCRIPTION OF THE INVENTION

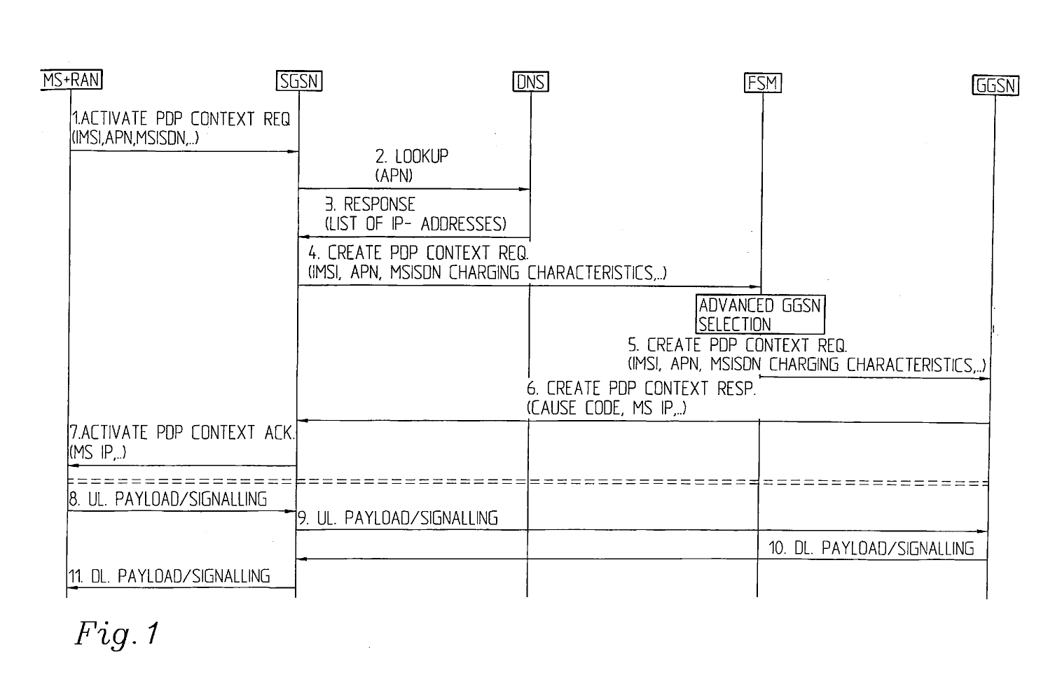

In the sequence diagram of FIG. 1 an MS (or UE etc.) sends an activate PDP Context request to an SGSN, 1, (it should be clear that the inventive concept of course also is applicable when CGSN:s are used; SGSN is then taken to mean the SGSN part of the CGSN and GGSN means the GGSN part of the CGSN; in the following is however simply referred to SGSN or GGSN). This request contains information such as IMSI, APN, MSISDN etc. SGSN e.g. sends BIND messages “lookup” to a DNS, with APN, 2. DNS returns a response to SGSN with a list of IP addresses to one or more functional selection means (also called GTP directors, since they e.g. use GPRS Tunneling Protocol), 3.

In a conventional manner SGSN then provides a Create PDP Context request and sends it to the, or one of the, functional selection means, 4. If there are several such means, e.g. for redundancy reasons the one to be used may be established in any appropriate manner, in any appropriate order, or randomly, or according to some algorithm, e.g. Round Robin.

Using at least some of the information in the Create PDP Context request, and possibly some other information available to the functional selection means, which may be different depending on where the functional selection means are implemented; if for example in SGSN generally more information is available concerning the mobile user station, e.g. about its location, MSC, HW-id etc.

Then the functional selection means performs a selection of GGSN based on some or all existing information available (during the PDP Context creation). Only the PDP Context set up message is routed via the functional selection means, or its logic, i.e. all subsequent GTP traffic of a specific PDP Context shall be unaffected.

The functionality, of the functional selection means, can be placed at different locations, e.g. integrated in SGSN, GGSN, CGSN, in other node(s) in the packet core networks, in DNS or as a stand-alone node or as an “add-on” component/function.

The network configuration and characteristics differ between different architectural solutions.

The advanced GGSN selection according to the invention shall be based on the information in the PDP Context establishment dialogue (and possible other information as well).

Thereafter the functional selection means sends the PDP Context request to the selected GGSN, 5.

The selected GGSN returns a Create PDP Context response directly to SGSN, 6. SGSN sends an activate PDP Context acknowledgement to MS, 7. Further UL/DL signalling/payload is sent as usual (unaffected).

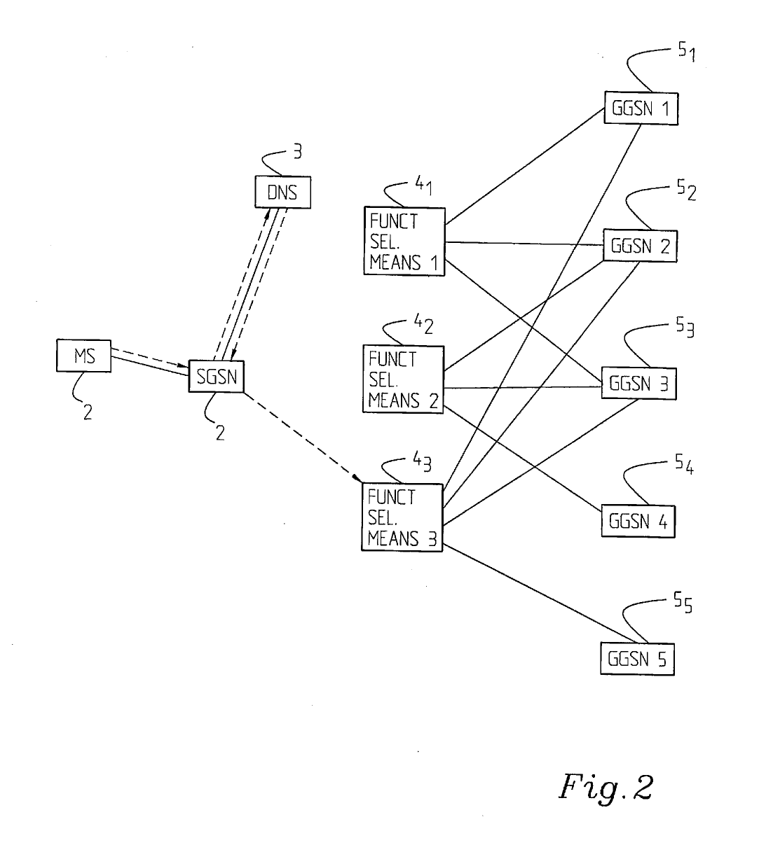

FIGS. 2-5 merely very schematically illustrate examples on where and how the functional selection means can be implemented.

FIG. 2 shows one example of an arrangement in which functional selection means FSM 4₁, 4₂, 4₃ are implemented as stand-alone functions or nodes (that there are three FSM:s of course only constitutes an example). It is here supposed that MS 1 sends an activate PDP Context request to SGSN 2, which sends a BIND message to DNS 3, which as explained with reference to FIG. 1 responds with a list of IP addresses to FSM 4₁, 4₂, 4₃. Using e.g. a Round Robin algorithm SGSN 3 selects FSM 2 4₂, which uses information parameters as discussed above to select a GGSN, here GGSN 2 5₂.

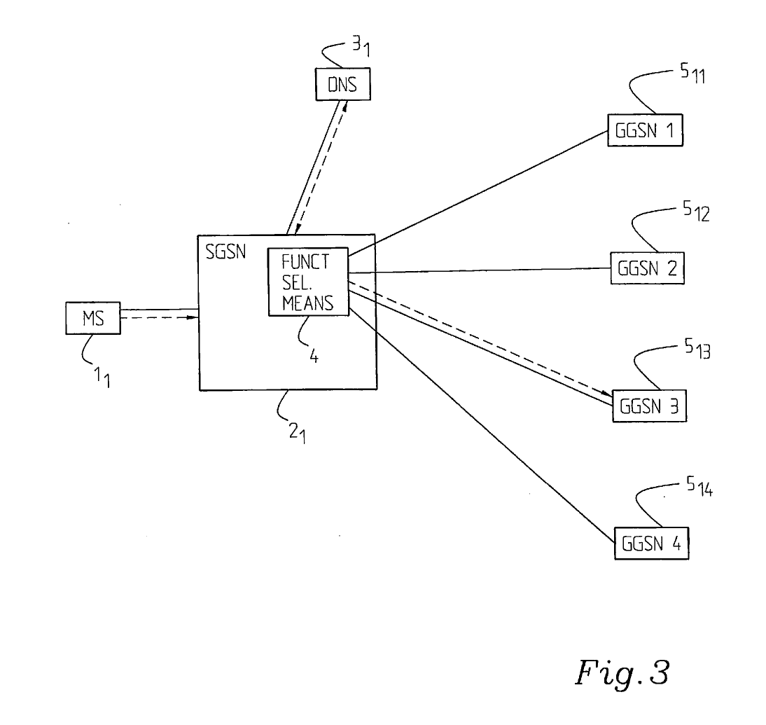

In FIG. 3 MS 1₁, sends an activate PDP Context request to SGSN 2, in which it here is supposed that FSM 4 is implemented. SGSN e.g. communicates with DNS 3₁, (which might not be necessary in this case), which here selects GGSN 3 5₁₃ based on the information parameters that are used.

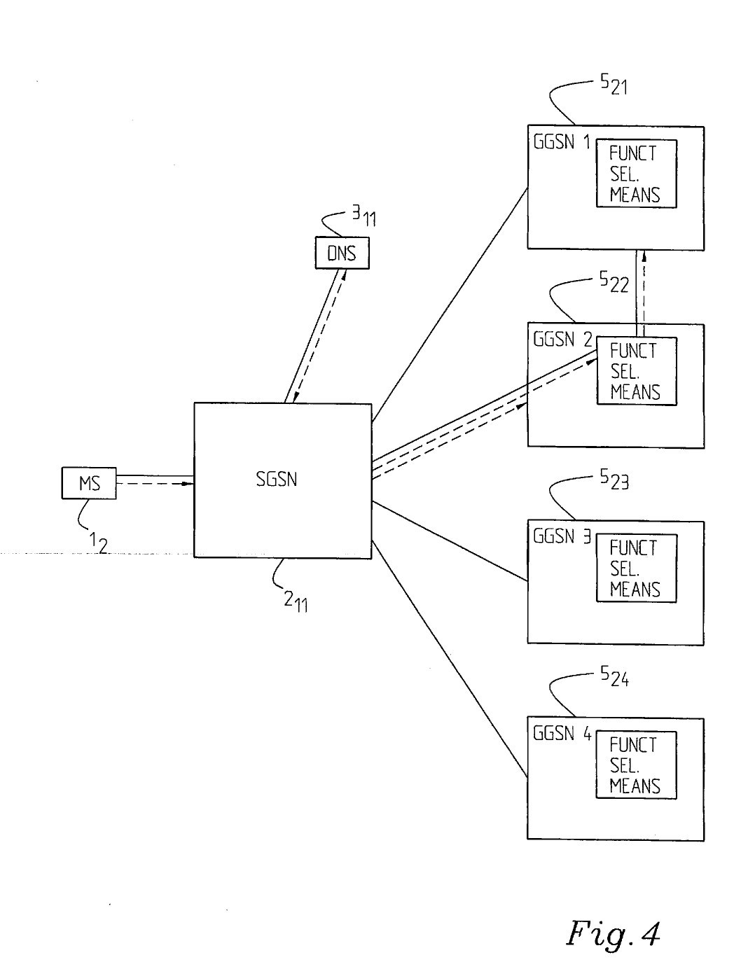

In FIG. 4 FSM 4′ implemented in GGSN 2 5₁₂ is used by SGSN 2₁₁ after address information reception from DNS 3₁₁ as discussed above. It is here supposed that GGSN 1 5₂₁ is selected, it might of course also have selected GGSN 2 5₂₂ (or any of the other GGSN:s depending on the used information).

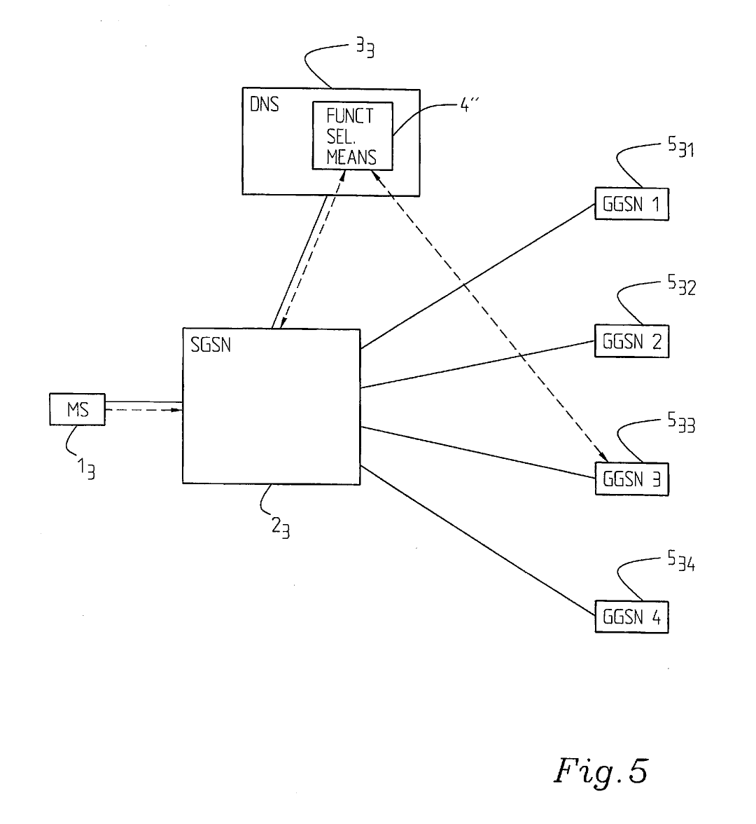

FIG. 5 exemplifies an embodiment in which an FSM 4″ is implemented in DNS 3₃. It is supposed that FSM 4″ selects GGSN 3 5₂₃.

It is an advantage of the present invention that it becomes possible to base the decision as to which GGSN to use on more criteria than today, which can open up for new commercial and technical aspects of network deployment.

It is also an advantage that it enables for operators to carry out a (more) sophisticated grouping of subscribers, e.g. local subnets based on e.g. IMSI and/or MSISDN. This may particularly be of interest for operators with large networks.

Still another advantage is that it enables the use of e.g. dedicated GGSN:s, i.e. a GGSN may be dedicated for a certain service or services, e.g. HSDPA, VoIP, pre-paid etc., or more generally different GGSN:s, e.g. higher capacity and lower capacity GGSN:s, newer/older GGSN:s, differently upgraded GGSN:s etc. may be used in a network of by an operator.

It should be clear that the invention is not limited to the specifically illustrated embodiments, but that it can be varied in a number of ways within the scope of the appended claims.

What is claimed:

1. An arrangement, in a communications system supporting communication of packet data, for selection of a packet data gateway node or function for a mobile user station (MS; UE), comprising:
a packet data gateway functional selection means, said gateway functional selection means adapted to use a plurality of information parameters contained in a context set up message to select a packet data gateway, and to forward the context setup message to the selected packet data gateway node or a packet data gateway function.

2. The arrangement according to claim 1, wherein the packet data gateway node comprises a GGSN or the GGSN functionality of a CGSN.

3. The arrangement according to claim 1, wherein the context set up message comprises a (primary) create PDP context request.

4. The arrangement according to claim 3, further comprising an SGSN or an SGSN part of a CGSN adapted to generate a create PDP context request at reception of an activate primary PDP context request form a mobile user station containing a number of information parameters.

5. The arrangement according to claim 4, wherein one of said information parameters is an Access Point Name (APN), and wherein the SGSN or SGSN function of a CGSN is adapted to send a lookup message containing said APN to a Domain Name Server (DNS), said Domain Name Server (DNS) adapted to return one or more IP addresses to a number of functional selection means.

6. The arrangement according to claim 5, wherein the DNS comprises information about which are the functional selection means that may be used for a number of given APN:s.

7. The arrangement according to claim 5, wherein the SGSN or the SGSN functionality of a CGSN is adapted to select gateway functional selection means using information about which are available from the DNS based on an algorithm or arbitrarily, randomly or in any given order or depending on given criteria.

8. The arrangement according to claim 1, wherein the information parameters are one or more of IMSI, MSISDN, APN, (IMPI, IMPU), charging characteristics, and service characteristics.

9. The arrangement according to claim 8, wherein the gateway functional selection means are adapted to forward the create PDB context request to the selected GGSN or GGSN function of a SGSN.

10. The arrangement according to claim 1, wherein the gateway functional selection means are implemented in a GGSN or in a SGSN or in a CGSN or in a DNS or as a stand alone function or as a stand-alone node.

11. The arrangement according to claim 1, wherein the gateway selection function means uses the GTP-protocol.

12. The arrangement according to claim 1, wherein the gateway functional selection means are adapted to exclusively be involved in messaging relating to selection of gateway.

13. A gateway functional selection means for use in a communications system supporting communication of packet data and for selection of packet data gateway node or function, comprising:
means to communicate with a number of SGSN:s, or SGSN functional parts of CGSN:s and with a number of GGSN:s or GGSN functional parts of CGSN:s;
means to select GGSN, or GGSN functional part of a CGSN, from a number of GGSN:s or CGSN:s, available for a given Access Point Name (APN) using one or more additional information parameters contained in a context set up message received from a SGSN, or the SGSN part of a CGSN.

14. The gateway selection function means according to claim 13, further comprising a stand-alone node or a stand-alone function or that it is implemented in a SGSN, or a SGSN part of a CGSN, or a GGSN or a GGSN part of a CGSN or in a DNS.

15. The gateway selection function means according to claim 13, further comprising means to use one or more of the information parameters contained in a create PDP context request, charging characteristics, service characteristics, or QoS.

16. The gateway selection function means according to claim 15, further comprising information about GGSN characteristics and/or extended information available in SGSN, said information being used in addition to one or more of said information parameters to select GGSN or GGSN of a CGSN.

17. A method for, in a communications system supporting communication of packet data, selecting packet data gateway node or gateway function for a mobile user station, comprising the steps of:
receiving a request for activation of a context from the mobile user station in an SGSN or SGSN part of a CGSN, said request containing a number of information parameters,
using at least a number of, preferably at least two, of said information parameters to select a gateway node or function in a functional selection means,
forwarding the create context request to the selected gateway node or function.

18. The method according to claim 17, further comprising the steps of:
subsequent to reception of the request for activation of a context, e.g. an activate (primary) PDP context request, in e.g. the SGSN:
sending a look up message with APN to a DNS;
responding from the DNS with a list of available IP addresses of available functional selection means to the SGSN;
choosing one of the functional selection addresses according to some given criteria, e.g. according to an algorithm or randomly or similar;
sending a create PDP context request to the chosen functional selection means using at least one or more of the information parameters, a gateway node or function e.g. GGSN; and,
sending the create PDP context request to the selected GGSN or similar from the functional selection means.
